(19) United States
(12) Patent Application Publication
(10) Pub. No.: US 2016/0288363 A1
(43) Pub. Date: Oct. 6, 2016

(54) STRIP COUPLING TENON FORMING MACHINE

(71) Applicant: CHENG KUANG WOOD MACHINERY WORKS CO., LTD., Taichung (TW)

(72) Inventors: CHIN-LIANG TU, Taichung (TW); I-LUN TU, Taichung (TW); SHIH-CHANG TSAI, Taichung (TW)

(21) Appl. No.: 14/672,609

(22) Filed: Mar. 30, 2015

(51) Int. Cl. B27M 1/08; B27F 1/08

(52) U.S. Cl. CPC B27M 1/08; B27F 1/08

(57) ABSTRACT

A strip coupling tenon forming machine for cutting a plurality of strips includes a station and a movement deck located on the station, a plane cutting device and a sawteeth cutting device. The movement deck has a holding deck to hold the strips, a slide element to carry and slide and swivel the holding deck and a rotary element. The rotary element has a holding bar anchored on the station and a rotary bar to support the holding deck. The rotary bar screws into the holding bar so that while the holding deck is swiveling its elevation also is changed. Thus, end surfaces at two sides of the strips can pass through respectively a plane cutter of the cutting device and a sawteeth cutter of the sawteeth cutting device to form respectively a coupling tenon thereon that are matched in elevation.

### FIELD OF THE INVENTION

The present invention relates to a strip coupling tenon forming machine and particularly to a strip coupling tenon forming machine for cutting strips.

### BACKGROUND OF THE INVENTION

Strips may include native woods, compound materials (regenerated woods), high polymers (plastics), metals and the like. Among them, woods are regenerating natural resources, thus are well-accepted environment-friendly materials, and widely used to make various types of products, such as furniture, artifacts, hand tools and the like. Woods also can be directly used as building materials to form beams, posts and light partitions and the like.

Tree is a natural growing material with the appearance looked like a cylindrical post. But each tree has a different shape and dimension, therefore has to be cut and sliced to form usable wood. In general, the price of same kind of wood increases exponentially with increasing dimensions. Namely, the wood of a larger dimension is priced much greater than that of a smaller dimension.

Therefore in order to increase the utilization value of wood the peripheral and remanent woods left after a tree is cut and sliced are generally being spliced to form usable woods. In addition, in order to meet use requirements woods of normal dimensions also can be spliced to form woods of a greater dimension. On high polymers (plastics) and metal strips, they usually have to be cut according to the length required before being used to meet use requirements. Recycling of the high polymers and metal strips through traditional melting process consumes a lot of energy, hence another approach of coupling and cutting them for reuse also is a desirable recycling practice.

Please refer to FIG. 1 for a conventional wire pressing machine 1 for splicing wooden strips 2a, 2b and 2c. The wooden strips 2a, 2b and 2c are remanent woods after cutting and slicing that are formed in shorter dimensions. They have to be spliced in a serial fashion to increase the length. To achieve such a purpose each end surface of two ends of the wooden strips 2a, 2b and 2c has to be fabricated first through a sawteeth cutting device (not shown in the drawings) to form a coupling tenon 3, then the coupling tenons 3 at two ends are glued and spliced together through the pressing machine 1. First, one end of the first wooden wire 2a is leaned on a leaning panel 4 of the pressing machine 1; next, make a coupling tenon 3 of the second wooden strip 2b in contact with another coupling tenon 3 of the first wooden strip 2a, and splice the third wooden strip 2c in this order; then through the thrust force of a thrust portion 5 and pressing of an upper press plate 6, the coupling tenons 3 of the wooden strips 2a, 2b and 2c can be coupled together in pair, thereby splice the wooden strips 2a, 2b and 2c together. In order to make the upper press plate 6 movable up and down a plurality of pylons 7 and upward movement elements 8 must be provided for driving.

Moreover, during forming the coupling tenons 3 on the two end surfaces of the wooden strips 2a, 2b and 2c, in order to make the coupling tenons 3 to match each other and couple in pair, their shapes must be formed with an elevation difference. Hence during fabrication of the coupling tenons 3 the elevation of the wooden strips 2a, 2b and 2c, or the sawteeth cutting device has to be adjusted manually to make the coupling tenons 3 formed at the end surfaces at two sides of the wooden strips 2a, 2b and 2c to match each other.

The aforesaid conventional fabrication practice is slow and difficult to do, operation errors easily take place that could result in non-matching of the coupling tenons 3 at the two end surfaces. Doing the process anew often is needed, hence cannot meet use requirements.

### SUMMARY OF THE INVENTION

The primary object of the present invention is to disclose a strip coupling tenon forming machine that can automatically change cutting elevation to meet fabrication requirements.

The strip coupling tenon forming machine according to the invention aims to cut a plurality of strips. It comprises a station, a plane cutting device, a sawteeth cutting device and a movement deck. The station has a working plane. The plane cutting device is mounted onto the working plane and has a plane cutter. The sawteeth cutting device is mounted onto the working plane and has a sawteeth cutter.

The movement deck is located on the station and has a holding deck to hold a plurality of the strips, a leaning panel located at one side of the holding deck, a clamp panel movable close to the leaning panel to clamp the strips, a slide element to carry and slide the holding deck, and a rotary element to carry and swivel the holding deck. The rotary element has a holding bar anchored on the station and a rotary bar to support the holding deck and screw into the holding bar. The rotary bar changes the elevation of the holding deck while the holding deck is swiveled. The rotary element makes two ends surfaces of the strips to move close to or away from the working plane through swiveling. The slide element makes the two end surfaces of the strips to pass through respectively the plane cutter and the tool cutter so that the two end surfaces have respectively a coupling tenon formed thereon.

Thus, through the mechanism design of swiveling the holding deck that also changes the elevation thereof at the same time, while the end surfaces at two sides of the strips are passing through the plane cutter of the plane cutting device and the sawteeth cutter of the sawteeth cutting device, the coupling tenons that are matched at varying elevations can be formed on the end surfaces so that the coupling tenons of the strips can be coupled together in a serial fashion. Such a technique can reduce rework caused by mismatching of the elevation and increase fabrication speed, and can be adopted to cut strips made of the native woods, compound materials (regenerating woods), high polymers (plastics), metals and the like to meet fabrication requirements.

The foregoing, as well as additional objects, features and advantages of the invention will be more readily apparent from the following detailed embodiments and description, which proceed with reference to the accompanying drawings. The embodiments merely serve for illustrative purpose and are not the limitation of the invention.

### BRIEF DESCRIPTION OF THE DRAWINGS

FIG. 1 is a schematic view of a conventional pressing machine for coupling strips.

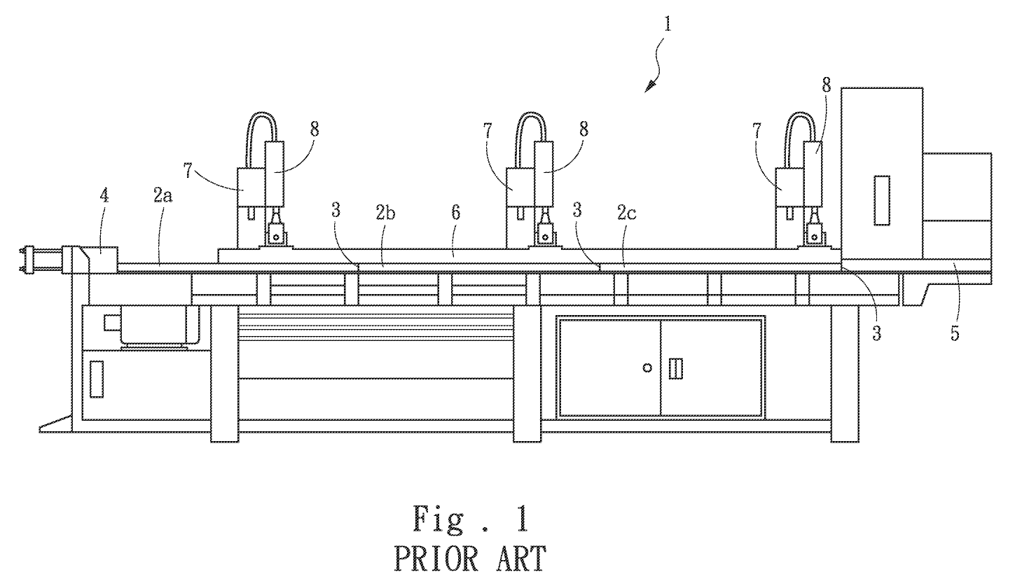

FIG. 2 is a perspective view of the invention.

FIG. 3A is a front view of the invention.

FIG. 3B is a front view of the invention after the rotary bar is rotated.

FIG. 4 is a schematic view of another embodiment of the invention in a use condition.

FIG. 5A is a schematic view of the invention in a use condition for coupling strips.

FIG. 5B is a schematic view of the invention in another use condition for coupling strips.

### DETAILED DESCRIPTION OF THE PREFERRED EMBODIMENTS

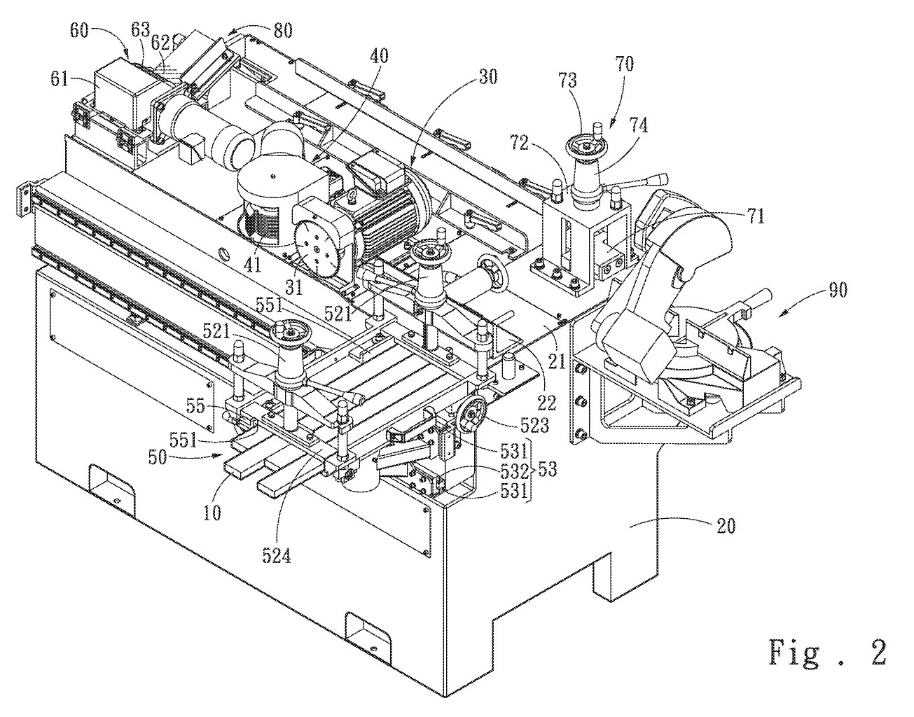

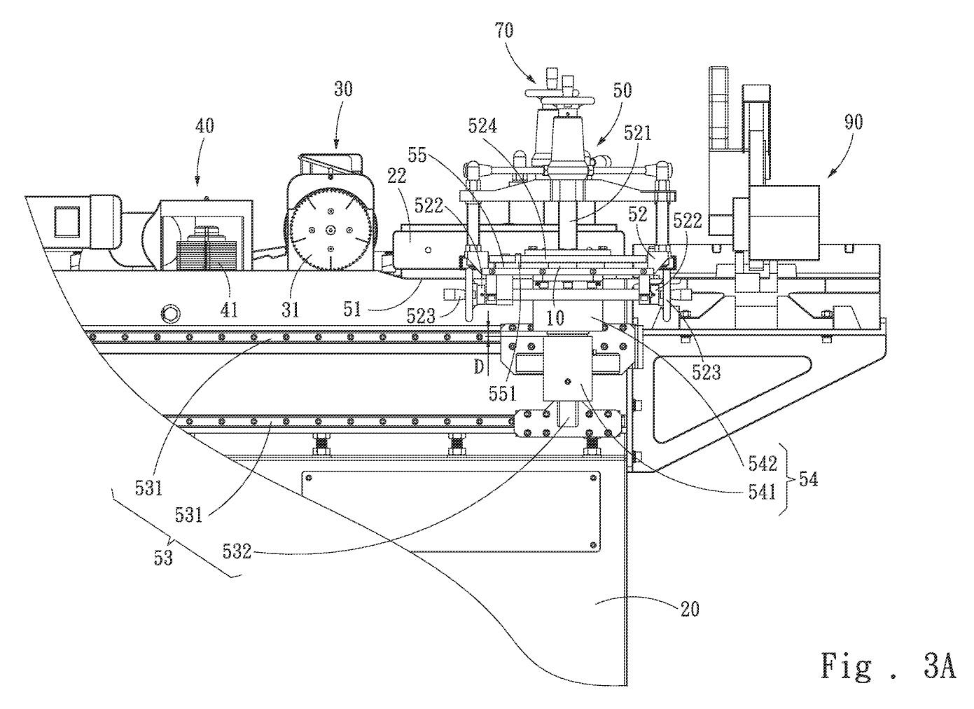

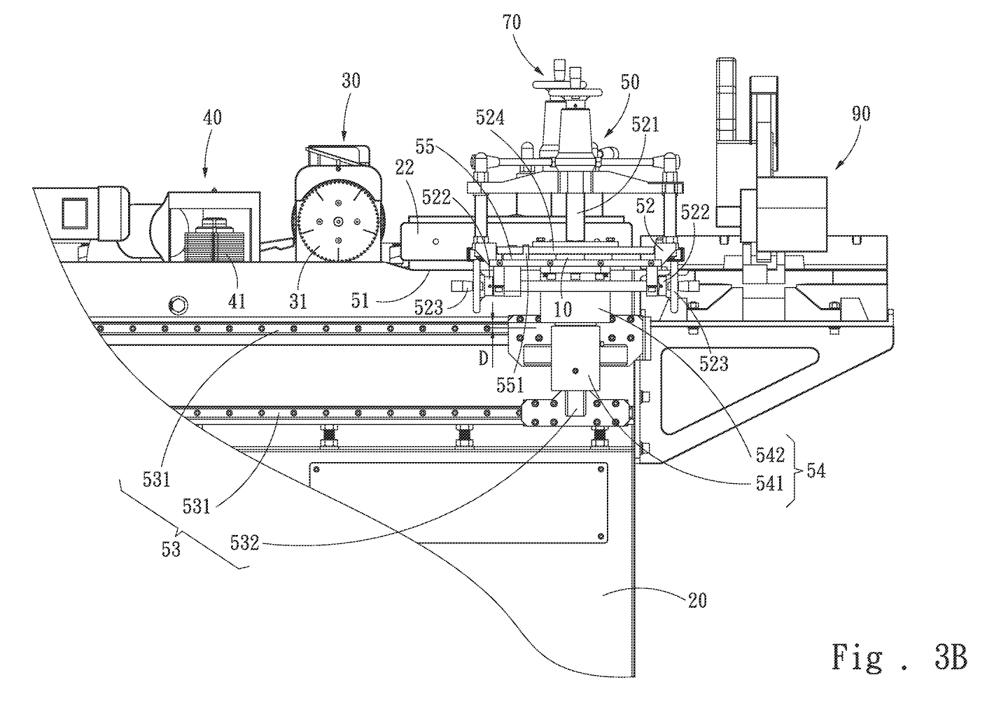

Please referring to FIGS. 2 and 3A, the present invention aims to provide a strip coupling tenon forming machine for cutting a plurality of strips 10 to couple with one another later. In the following discussion the strips 10 are wood as an example.

The invention comprises a station 20, a plane cutting device 30, a sawteeth cutting device 40 and a movement deck 50, and can be collaborated with a gluing device 60, a press device 70 and a thrust device 80 to couple the strips 10 together.

The station 20 has a working plane 21. The plane cutting device 30 is mounted onto the working plane 21 and has a plane cutter 31. The sawteeth cutting device 40 is mounted onto the working plane 21 and has a sawteeth cutter 41.

The movement deck 50 is located on the station 20 and has a holding deck 51 to hold the strips 10, a leaning panel 52 located at one side of the holding deck 51, a clamp panel 55 movable close to the leaning panel 52 to clamp the strips 10, a slide element 53 to carry and slide the holding deck 51, and a rotary element 54 to carry the holding deck 51 to swivel 180 degrees. The slide element 53 can have a directing member 531 anchored on the station 20 and a slide base 532 to carry the holding deck 51 and the rotary element 54.

The clamp panel 55 can include two clamp portions 551 screwed through respectively by a clamp screw bar 522. The two clamp screw bars 522 are connected respectively to a rotary wheel 523. Through rotation of the rotary wheels 523 the two clamp portions 551 are driven to move close to the stationary leaning panel 52 to clamp the strips 10.

The holding deck 51 can have a press member 521 located above the strips 10. The press member 521 is anchored on the holding deck 51 and includes a press plate 524 to press and hold the strips 10 still.

The working plane 21 can have a positioning plate 22 to be pressed by the strips 10 to trim the end surfaces at two sides of the strips 10 to pass through respectively where the plane cutter 31 and the sawteeth cutter 41 are located, and after the positioning is finished the strips 10 are clamped tightly by the clamp panels 55 for positioning.

The strips 10 are located on the holding deck 51 with the end surfaces jutting outside the holding deck 51, and through sliding of the slide element 53 and swiveling of the rotary element 54, the two end surfaces at two sides of the strips 10 can pass through respectively the plane cutter 31 and the sawteeth cutter 41 to form respectively a coupling tenon 12 thereon. It is to be noted that after the rotary element 54 has swiveled the two end surfaces at two sides of the strips 10 have to be trimmed again through the positioning plate 22 to pass through the plane cutter 31 and the sawteeth cutter 41. In the event that no rotary element 54 is provided, the strips 10 can be swiveled manually to form the coupling tenons 12 on the end surfaces at two sides of the strips 10.

Please also referring to FIG. 3B, the rotary element 54 has a holding bar 541 anchored on the station 20 and a rotary bar 542 to support the holding deck 51. The rotary bar 542 screws into the holding bar 541. The holding bar 541 and the rotary bar 542 are spaced from each other at a relative distance D which is changeable with rotation of the rotary bar 542, hence while the holding deck 51 is swiveled for 180 degrees its elevation also is changed at the same time to allow the coupling tenons 12 on the two end surfaces of the strips 10 staggered up and down at a selected distance so that a desired coupling can be formed. The holding deck 51, aside from changing the elevation through rotation also can achieve the same purpose through an elevation adjustment element (not shown in the drawings). Operation of the elevation adjustment element can be accomplished manually, electrically, pneumatically or the like, details are omitted herein.

The gluing device 60 is mounted onto the working plane 21 and has a glue box 61 which is got into by the coupling tenons 12 of the strips 10. The glue box 61 contains a glue 62 to daub on the coupling tenons 12. The glue box 61 also can include a serrated glue dispensing wheel 63 inside corresponding to the coupling tenons 12 so that even small crevices of the coupling tenons 12 can be daubed with the glue.

The press device 70 is mounted onto the working plane 21 and includes a press plate 71 movable up and down to press the strips 10 at a definite pressure to generate a static friction force between the strips 10 and the working plane 21. The press device 70 can include a pylon 72 which has a revolving wheel 73 and a pylon screw bar 74. The pylon screw bar 74 screws through the pylon 72 and has a distal end fastened to the press plate 71. By rotating the revolving wheel 73 the elevation of the press plate 71 can be changed to hold the strips 10 to avoid the strips 10 from rotating or skewing in the downstream fabrication processes.

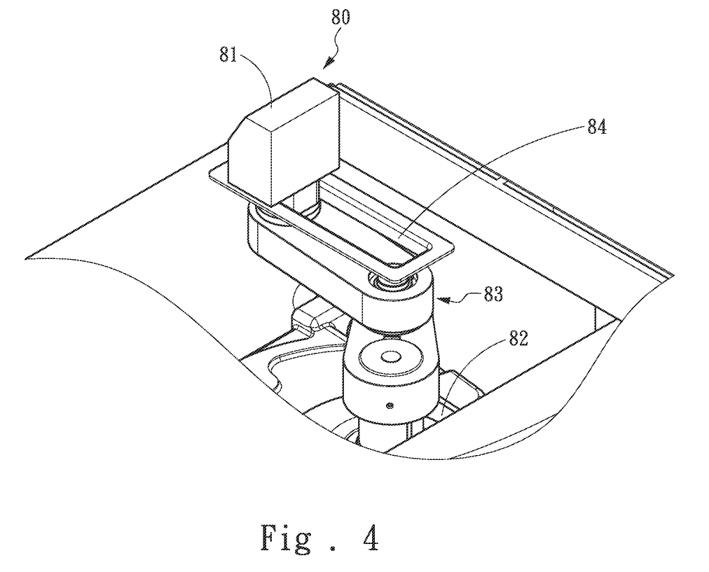

Please also referring to FIG. 4, the thrust device 80 is mounted onto the working plane 21 and includes a thrust portion 81 which has a movement path toward the press plate 71. The thrust device 80 also has a driving power source 82, a link movement mechanism element 83, and a slide slot 84 to hold the thrust portion 81. The link movement mechanism element 83 has two ends connected respectively to the driving power source 82 and the thrust portion 81. The driving power source 82 drives the link movement mechanism element 83 and also moves the thrust portion 81 upward on the slide slot 84. When the thrust portion 81 pushes two coupling tenons 12 in a fully coupled condition the thrust force of the thrust portion 81 is greater than the static friction force, hence the strips 10 slide on the working plane 21. As a result, at the instant when the two coupling tenons 12 are fully coupled, they can absorb excessive impact force to avoid the strips 10 from fracturing, meanwhile, also avoid the strips 10 from warping at the junction of the coupling tenons 12 caused by too much forces received by the strips 10. The driving power source 82 can be an electric motor, hydraulic force, animal force, human force or the like, as long as it can drive the thrust portion 81 moving.

In addition, the plane cutting device 30 and the sawteeth cutting device 40 can be positioned on the same side of the working plane 21, while the thrust device 80 and the press device 70 on another side of the working plane 21 so that the plane cutting device 30, the sawteeth cutting device 40, the thrust device 80 and the press device 70 surround the working plane 21, namely, the equipment required to press and couple the coupling tenons 12 are surrounding the working plane 21 and located on the same station 20.

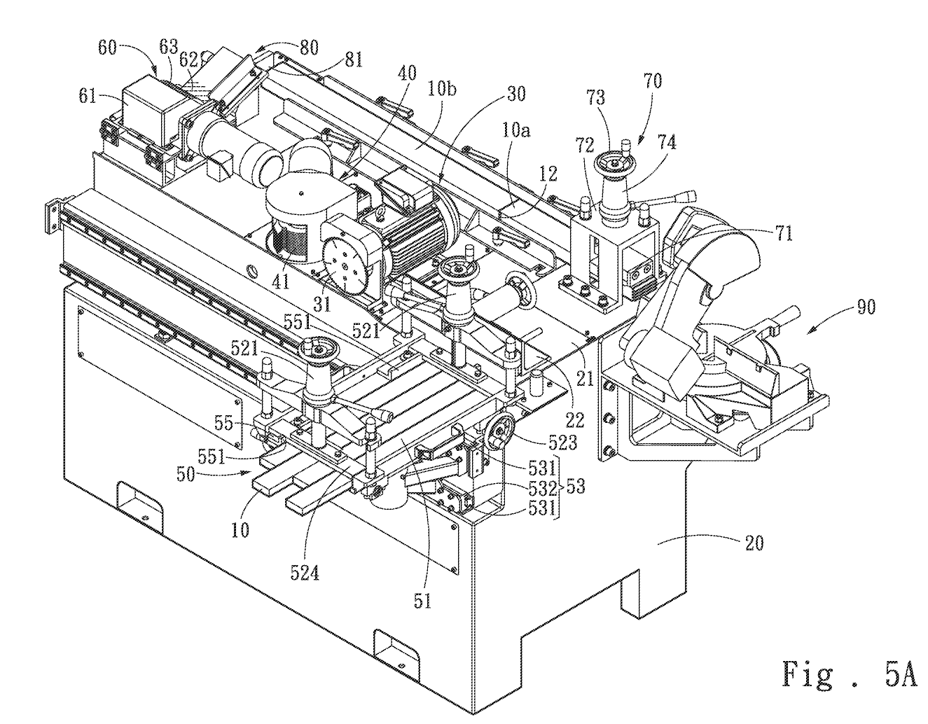

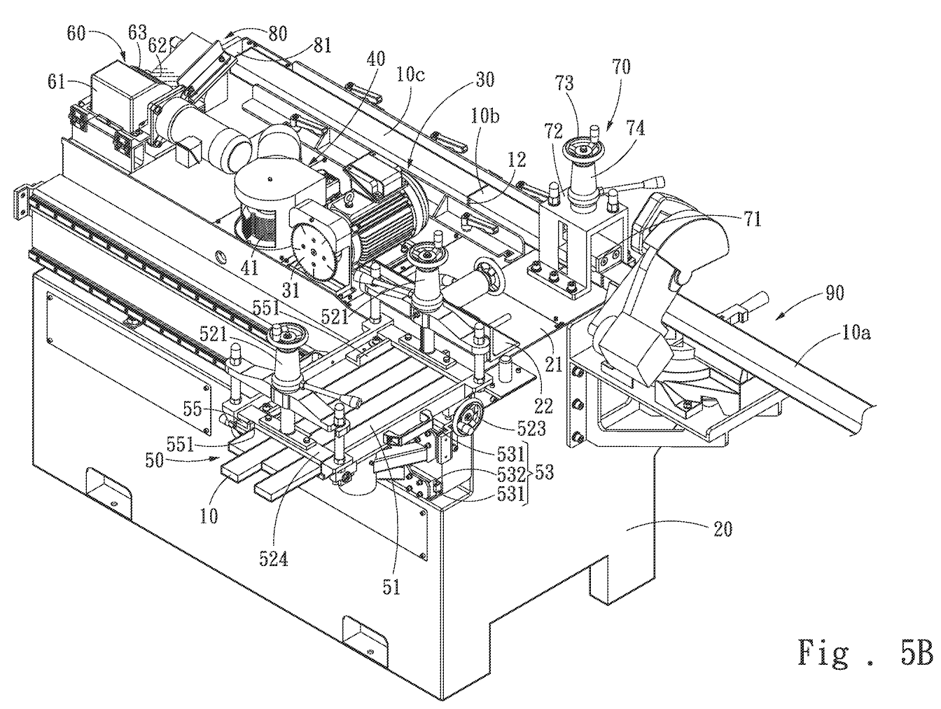

Also referring to FIGS. 5A and 5B, during actual coupling process of the strips 10 any one of the strips 10 (such as a first strip 10a) can be held stationary by the press plate 71, and the coupling tenon 12 faces the thrust portion 81, while the thrust portion 81 pushes another strip 10 (such as a second strip 10b) to move the two coupling tenons 12 close to each other and couple together (as shown in FIG. 5A). When the two coupling tenons 12 have been coupled together, but the thrust portion 81 continues pushing, the strips 10a held by the press plate 71 slides away to avoid the strip 10 from the risk of fracturing; when a next strip 10 (such as a third strip 10c) is to be coupled, if the retreated thrust portion 81 has enough space to accommodate the strip 10c, it can be directly placed; if the space is not sufficient, the press plate 71 can be loosened and moved outward (with a movable support station to support the first strip 10a), then hold the strip 10 (the second strip 10b) stationary via the press plate 71, then a sufficient space can be generated to hold the strip 10c, and the thrust portion 81 can push the strip 10 (the third strip 10c) to move the two coupling tenons 12 close to each other and couple together (as shown in FIG. 5B). After the coupling is finished, it can be cut via a cutting machine 90 to get a length desired to meet use requirement. The invention thus formed is adaptable for cutting of strips made of native woods, compound materials (regenerated woods), high polymers (plastics), metals and the like.

As a conclusion, the invention can provide many advantages, notably:

1. With the rotary bar screwed into the holding bar the elevation of the holding deck can be changed while it is swiveling for 180 degrees so that the coupling tenons on the two end surfaces of the strips can be staggered up and down for a selected distance to form desired coupling.

2. Through the approach of automatic change of elevation human operation errors can be eliminated, and rework can be reduced, hence fabrication cost decreases.

3. Through the press member the strips can be pressed effectively to avoid loosening of the strips and improve production yield.

4. Through the positioning plate the end surfaces of the strips can be trimmed neatly and quickly.

What is claimed is:

1. A strip coupling tenon forming machine for cutting a plurality of strips, comprising:
a station including a working plane;
a plane cutting device mounted onto the working plane and including a plane cutter;
a sawteeth cutting device mounted onto the working plane and including a sawteeth cutter; and
a movement deck mounted onto the station and including a holding deck to hold the strips, a leaning panel at one side of the holding deck, a clamp panel movable close to the leaning panel to clamp the strips, a slide element to carry and slide the holding deck and a rotary element to carry and swivel the holding deck, the rotary element including a holding bar anchored on the station and a rotary bar to support the holding deck and screw into the holding bar to change the elevation of the holding deck while it is swiveling, the rotary element making two end surfaces of the strips to move close to or away from the working plane, the slide element making the two end surfaces of the strips to pass through respectively the plane cutter and the sawteeth cutter to form respectively a coupling tenon on the two end surfaces.

2. The strip coupling tenon forming machine of claim 1, wherein the holding deck includes a press member anchored thereon, the press member including a press plate to hold and press the strips stationary.

3. The strip coupling tenon forming machine of claim 1, wherein the clamp panel includes two clamp portions screwed through respectively by a clamp screw bar, the two clamp screw bars connecting respectively to a rotary wheel.

4. The strip coupling tenon forming machine of claim 1, wherein the working plane includes a positioning plate pressed by the strips, the trimmed end surfaces of the strips passing through where the plane cutter and the sawteeth cutter are located.
